(19) United States
(12) Patent Application Publication
(10) Pub. No.: US 2012/0251979 A1
(43) Pub. Date: Oct. 4, 2012

(54) DENTAL IMPLANT MILL BLANK ARTICLES AND METHODS

(76) Inventors: Naimul Karim, Maplewood, MN (US); Ryan E. Johnson, St. Paul, MN (US); Roger K. Dawson, Excelsior, MN (US)

(21) Appl. No.: 13/395,711

(22) PCT Filed: Oct. 21, 2010
(86) PCT No.: PCT/US10/53548

§ 371 Date: Mar. 13, 2012

Related U.S. Application Data
(60) Provisional application No. 61/255,638, filed on Oct. 28, 2009.

(51) Int. Cl. A61C 8/00; B05D 3/00; B05D 7/00

(52) U.S. Cl. 433/201.1; 427/2.29

(57) ABSTRACT

Methods of fabricating a dental restoration from dental mill blanks that further comprise a dental implant abutment integrated therein are described. Also described are dental mill blanks and dental prosthesis articles and methods of making dental mill blanks.

### BACKGROUND

As described in US 2005/0147944, materials used to make dental prostheses typically include gold, ceramics, amalgam, porcelain, and composites. For dental restorative work such as fillings, amalgam is a popular choice for its long life and low cost. Amalgam also provides a dental practitioner the capability of fitting and fabricating a dental filling during a single session with a patient. The aesthetic value of amalgam, however, is quite low, as its color drastically contrasts to that of natural teeth. For large inlays and fillings, gold is often used. However, similar to amalgam, gold fillings contrast to natural tooth colors. Thus, dental practitioners are increasingly turning to ceramic or polymer-ceramic composite materials because the color of these materials can be more closely matched with that of natural teeth.

The conventional procedure for producing dental prosthetics by hand typically requires the patient to have at least two sessions with the dentist. First, an impression is taken of the dentition using an elastomeric material from which a cast model is made to replicate the dentition. The prosthetic is then produced from the model using metal, ceramic or a composite material. A series of steps for proper fit and comfort then follows. This fabrication process is lengthy (1-2 days), labor intensive, and requires a high degree of skill and craftsmanship. Alternatively, a practitioner may opt for a sintered metal system that may be faster; however, such procedures are still labor intensive and quite complex.

In recent years, technological advances have provided computer automated machinery capable of fabricating prostheses using minimal human labor and drastically lower work time. This technology, in which computer automation is combined with optics, digitizing equipment, CAD/CAM (computer-aided design/computer aided machining) and mechanical milling tools, is frequently referred to as “digital dentistry.” Such computerized machining processes produce dental prostheses by cutting, milling, and grinding the near-exact shape and morphology of a required restorative with greater speed and lower labor requirements than conventional hand-made procedures.

Fabrication of dental prostheses using a CAD/CAM device typically involves use of a “mill blank,” a solid piece of material from which the prosthetic is cut or carved. The mill blank is typically made of ceramic material.

Many commercially available dental mill blanks are made of a two-piece construction that comprises a support stub section and a milling blank section. (See for example U.S. Pat. No. 6,627,327) The support section is cylindrical and adapted to fit into a collet or a Jacobs chuck of a milling machine. Often, the support section is made of metal, since the support section is ultimately detached from the milling section and does not form part of the finished prosthetic. The support section is typically made of a relatively soft metallic material such as an aluminum alloy that is easy to machine to precise tolerances.

As described for example in the Background of US 2007/0031793, a widely-used form of dental implant fixture, includes a generally cylindrical body which is implanted in a cylindrical bore made in the patient's jawbone (i.e., an endosseous implant) at the site of a edentulous ridge or tooth extraction socket, and having an internally-threaded cylindrical socket in which to fasten components used for attaching a permanent restoration to the implant fixture once the jawbone and gumline are healed. Prior to healing, the abutment is releasably fastened into cylindrical body by screwing threads into the implant socket. Once the abutment is releasably secured in place, the appropriately sized pre-fabricated temporary attachment is placed over abutment such that the void is mated with abutment properly adjusted (interproximally and occlusally), and the crown is secured in place using a suitable temporary dental fixative. The temporary abutment and temporary attachment may generally be left in place for period of time, e.g., 2 months, 3 months, 6 months, etc. sufficient to allow for healing of the patient's jawbone and gumline. Once healed, the temporary attachment may be removed, and a permanent restoration put in place on the implant fixture, as known in the art.

Certain dental mill blanks concerning dental implants or abutments have been described. See for example U.S. Pat. No. 6,126,445; WO 2008/069620; US2008/0254414, and US2008/0206711.

### SUMMARY

In one embodiment, a method of making a dental restoration for a dental implant is described. The method comprises acquiring a digital surface representation of at least a portion of a patient's mouth comprising a dental implant; creating a three-dimensional digital model from the digital surface representation; and forming a restoration from the three-dimensional digital model by milling a dental mill blank. The dental mill blank comprises a dental implant abutment integrated therein and the dental implant abutment comprises an orientation feature.

In another embodiments, dental mill blanks are described. In one embodiment the dental mill blank comprises a preformed dental implant abutment comprising a subgingival implant-receiving end and an opposing supragingival end wherein the supragingival end comprises an orientation feature and the supragingival end is permanently bonded within a solid piece of material from which a dental restoration can be milled.

The inclusion of the orientation feature aids in the fabrication and placement of the prosthesis. The orientation feature may comprise digital information, at least one visual feature, at least one mechanical feature, or a combination thereof. The mechanical feature may comprise a vertical groove, vertical protusion, vertical flat, or a combination thereof. In a favored embodiment, the supragingival end of the implant abutment has an asymmetrical cross-section.

Such methods and articles are advantageously amenable to fabricating dental prosthesis in the absence of making a physical model. In this embodiment, the method comprises attaching a dental implant abutment to the dental implant in the patient's mouth; and scanning the patient's mouth to acquire the digital surface representation.

Alternatively however, the method may comprise attaching a dental implant abutment to a physical model of the patient's mouth and scanning the physical model.

In preferred embodiments, the scanned dental implant abutment has the same geometry as the dental implant abutment of the mill blank, thereby reducing the number of separate parts and facilitating the fabrication of the restoration.

Other embodied dental mill blanks that are described herein comprise a preformed dental implant abutment comprising a subgingival implant receiving end and an opposing supragingival end wherein at least the supragingival end is permanently bonded within a solid piece of material. In one embodiment, the solid piece of material is a wax material and the mill blank is suitable for forming a dental restoration intermediate. In another embodiment, the solid piece of material is polymer or polymer-ceramic composite. In another embodiment, the solid piece of material further comprises a bore or partial bore for providing access to an internal bore of the implant abutment. In another embodiment, the solid piece of material is attached to a holder (such as a mandrel or frame).

Also described are dental prosthesis comprising a preformed dental implant abutment comprising a subgingival implant-receiving end and an opposing supragingival end; wherein the supragingival end is bonded within a (e.g. milled) dental restoration at an interface and the interface is free of cement and adhesive.

The dental implant abutment can be integrated within the solid piece of material by various methods as described herein.

In favored embodiments, the interface between the dental implant abutment and dental mill block material or (e.g. crown) prosthesis is free of cement and adhesive.

The methods and articles described herein may have any combination of features described herein.

### BRIEF DESCRIPTION OF THE DRAWINGS

FIG. 1 is a block diagram of a method of making a restorative for a dental implant;

FIG. 2 is a perspective view of an illustrative dental mill blank comprising a dental implant abutment;

FIG. 3 is a photograph of a bottom view of a dental mill blank comprising a dental implant abutment having a mandrel holder;

FIG. 4 is a photograph of a bottom view of a dental mill blank comprising a dental implant abutment in a frame holder;

FIG. 5 is a photograph of a dental implant abutment.

### DETAILED DESCRIPTION

Presently described are methods of fabricating a dental restoration from dental mill blanks that further comprise a dental implant abutment integrated therein, dental mill blanks, dental prosthesis, and methods of making dental mill blanks. The preformed dental implant abutment is permanently bonded to a dental mill blank prior to use (e.g. as packaged) or as received by the dental practitioner.

As used herein “dental mill blank” refers to a solid piece of material from which a restoration, such as a crown or bridge, can be formed by a subtractive milling. As used herein, “milling” refers to abrading, polishing, controlled vaporization, electronic discharge milling (EDM), cutting by water jet or laser or any other method of cutting, removing, shaping or carving material. The milling is generally conducted predominantly by a machine. Blanks may be made in any desired shape or size, including cylinders, bars, cubes, polyhedra, ovoids, and plates.

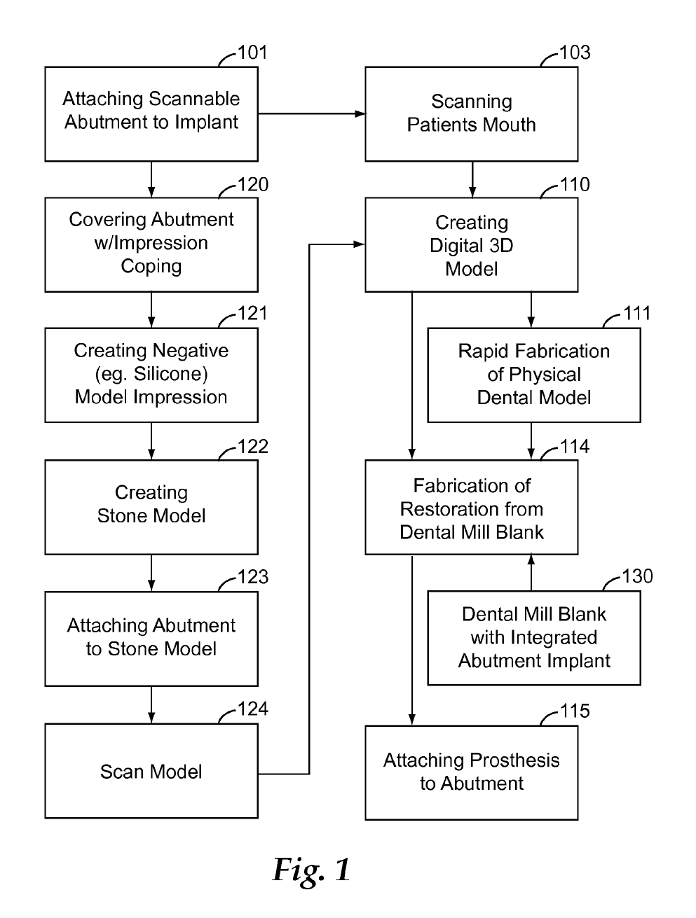

In one embodiment, a method of making a dental restoration is described. With reference to FIG. 1, the method comprises acquiring a digital surface representation of at least a portion of a patient's mouth comprising a dental implant. The digital representation may be acquired by attaching a dental implant abutment to a dental implant in a patient's mouth 101 and scanning at least a portion of the patient's mouth at a location of the dental implant abutment. Acquiring digital surface representation of intraoral structures is generally known. For example, U.S. Pat. No. 7,698,014; incorporated herein by reference, describes a method of acquiring a digital surface representation of one or more intraoral surfaces and processing the digital surface representation to obtain a three-dimensional model. Alternatively, the digital representation may be acquired by attaching a dental implant abutment to a physical (e.g. stone) model 123 and scanning the physical model 124. For example, with reference to FIG. 1, a dental model could be made by traditional dental impression techniques such as by covering the dental implant abutment with an impression coping 120, forming a negative (e.g. silicone) impression of the patient's mouth 121 (that comprises the impression copings cured therein), and forming a positive (e.g. stone) model from the negative impression 122. One could then attach the implant abutment to the model and scan the model 124. If a physical model is desired, it is preferably formed by use of a (e.g. additive) rapid prototyping 111 as described in pending U.S. Provisional Application No. 61/242,543, filed Sep. 15, 2009; incorporated herein by reference.

Regardless of the method of acquiring the digital surface representation, the method comprises creating a three-dimensional digital model from the digital surface representation 110 and fabricating a restoration from the three-dimensional digital model 114 by milling a dental mill blank. The dental mill blank comprises a dental implant abutment integrated therein 130.

The dental implant abutment has been adapted to be suitable for use as an orientation tool, also known as a “scan locator” as described in Pending U.S. Provisional Application Ser. No. 61/242,546, filed Sep. 15, 2009; incorporated herein by reference. To serve this purpose, the supragingival end of the dental implant comprises at least one orientation feature. By inclusion of such orientation feature, the implant abutment conveys information about the position and orientation of the underlying dental implant. In favored embodiments, the dental mill blank has an implant abutment having the same geometry as the dental implant abutment scan locator, thereby reducing the number of different parts needs in generating a prosthesis for a dental implant.

It is surmised that when the implant abutment being scanned is identical in geometry to the implant abutment within the dental mill blank, a permanent restoration can be fabricated without making a physical model. However, if desired, one could also make a physical model of the patient's mouth at the location of the dental implant, as known in the art.

A permanent restoration, such as a crown or bridge, is then fabricated from then dental mill blank 114 having the dental mill blank integrated therein.

Dental implant abutments and abutment interfaces are preformed articles comprised of a metal such as stainless steel, aluminum, and most commonly titanium or a titanium alloy. Typically, the abutment is comprised of a (e.g. milled) ceramic material. In some embodiments, the abutment is a different material than the mill blank material. In some favored embodiments, the abutment is a metal abutment or metal abutment interface and the mill blank is a ceramic or polymer-ceramic composite material.

A variety of dental implant abutment designs can be integrated into the dental mill blank, such as commercially available from Straumanns, 31, Astra tech, Zimmer, and Nobel.

In some embodiments, the (e.g. permanent) implant abutment is a preformed (e.g. one piece) abutment having a (e.g. hex-shaped) implant (e.g. anchor) receiving end and an opposing supraginvial end. Alternatively, the (e.g. permanent) implant abutment may be a (e.g. metal/ceramic) hybrid abutment. For example, the implant abutment may comprise a preformed metal abutment that is an abutment interface having an implant-receiving end for attachment to a tooth implant (e.g. anchor) and an opposing end comprising a ceramic abutment “top” as can be prepared from Lava™ Zirconia available from 3M ESPE. Unless specifically stated otherwise, the term “implant abutment” as used herein also encompasses implant abutment interfaces having an abutment as well.

When the dental implant abutment is a metal implant abutment or made from some other material that is not tooth-colored, it may be advantageous to coat at least the supragingival surfaces with an opaque (e.g. tooth-colored) coating to mask the appearance of the preformed metal abutment, thereby improving the aesthetic appearance of the subsequently fabricated dental (e.g. crown or bridge) restoration, such as described in Pending U.S. Application Ser. No. 61/242,546, filed Sep. 15, 2009. Such coatings generally comprise a polymeric binder and at least one opaque filler and/or pigment. The inclusion of the coating can alter the reflection properties of a metal abutment. The coating can increase the total reflection of the metal abutment such that the total reflection is at least 25%, 30%, 40%, 45%, 50%, or 55% at wavelengths of visible light. Increasing the total reflection can render a metal abutment optically scannable, eliminating the need to apply a particulate opacifying agent.

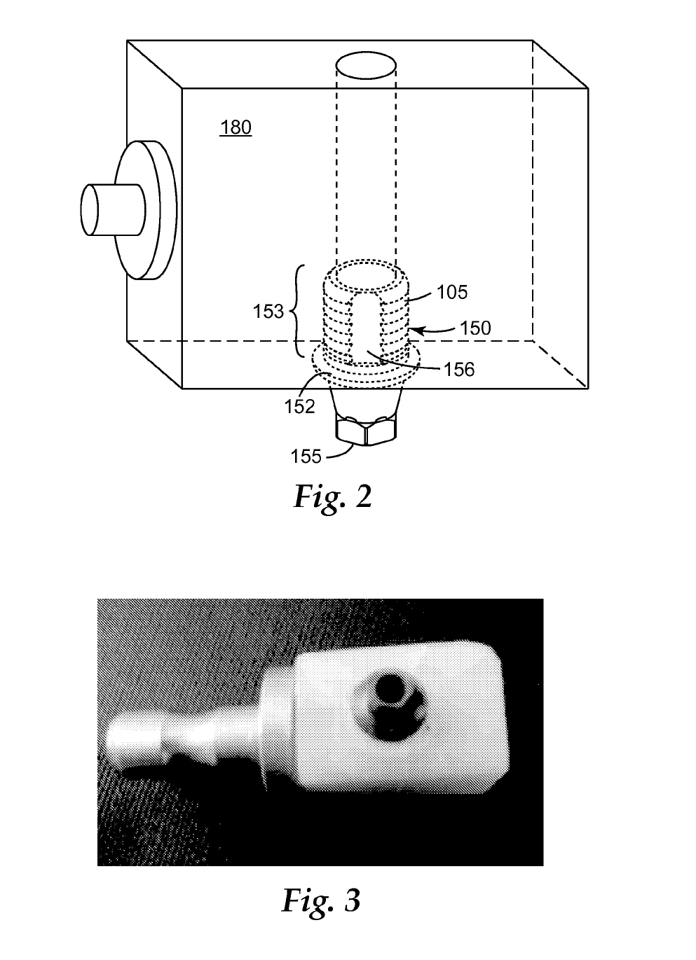

With reference to FIG. 2, a perspective view of an illustrative preformed implant abutment (e.g. interface) 150, the implant abutment may take the form of an elongated tubular body generally comprising a (e.g. hex shaped) base end 155 that is designed to mate with the implant (e.g. anchor) and an opposing supragingival end 153. The supragingival end is permanently bonded to the mill blank 180, a solid piece of material from which a dental restoration can be milled.

As depicted in FIG. 2, the implant abutment is typically provided within the mill blank material such that the platform 152 and suprgagingival end above such platform are contacting and are permanently bonded to the dental mill blank material. The subgingival implant-receiving end of the implant is typically exposed, as depicted in FIGS. 1 and 2. Although in FIG. 2 the subgingival implant-receiving end protrudes from the outer surface of the dental mill blank, the subgingival implant-receiving end may alternatively be recessed, e.g. such that the (i.e. bottom) surface of the hex is in the same plane as the (i.e. bottom) surface of the mill blank. Alternatively, the entire implant abutment (i.e. including the implant-receiving end) may be provided within the dental mill block material. The material covering the implant-receiving end can then be removed during the milling process.

Abutments that include a platform are commercially available from Nobel Biocare under the trade designation “Easy Abutment”. Alternatively, the abutment may lack a platform. In such embodiment, the supragingival end of the dental implant (that is intended to receive a (e.g. cemented) prefabricated dental restoration) is provided within the dental mill blank. Exemplary abutments that lack a platform are commercially available from Straumann ITI.

Regardless of design, the implant abutment generally comprises a gingival (e.g. platform) section between the subgingival and supragingival ends of the implant abutment. Further, the supragingival end protrudes into the mill blank material, having a contacting surface area greater than a cross-section of implant abutment at the gingival section. The increase in surface area can vary depending on the dental restoration. The increase in surface are can be at least 10%, 20%, 30%, 40%, 50%, or greater, particularly when the dental restoration is a crown.

Implant abutments typically comprise one or more anti-rotation features as known in the art. For example, the subgingival end of the abutment that mates with the implant (e.g. anchor) are typically hexagonal 155 in shape that can prevent the rotation of the implant abutment within the bore of the implant (e.g. anchor). The supragingival end of the implant abutment may also comprise one or more anti-rotation features that can prevent rotation of the implant abutment within the dental mill blank material. The supragingival end may include for example vertical flat(s), vertical groove(s), or vertical protrusion(s).

As further depicted in FIG. 2, the supragingival end of the implant abutment preferably comprise one or more anti-pull features, such as shallow grooves 105 that hinder removal of the abutment from the dental mill blank. In some embodiments, such anti-pull features have a depth no greater than about 0.1 mm. Other anti-pull features include for example shallow horizontal flat(s), horizontal groove(s), or horizontal protrusion(s). Such shallow mechanical features or other surface roughening can increase the surface area and mechanically interlock with the surrounding dental mill blank material.

The exterior geometry of the implant abutment and (e.g. mechanical) orientation feature can be chosen to facilitate intraoral scanning as described in pending U.S. Application Ser. No. 61/242,546. In this embodiment, an implant abutment having the same geometry as the implant abutment that is used as a “scan locator” is integrated into the mill blank, thereby reducing the separated parts required and facilitating the fabrication of the restoration.

For embodiments wherein the dental implant abutment is also suitable for use as a “scan locator”, the supragingival end of the implant abutment comprises at least one orientation feature. The orientation feature may comprise digital information, at least one visual feature, at least one mechanical feature, or a combination thereof. The orientation feature preferably comprises a (e.g. single) mechanical feature such as a vertical groove, vertical protrusion, vertical flat (e.g. 156 of FIG. 2), or a combination thereof.

In another embodiment, the abutment comprises more that one (e.g. 2, 3, or 4) vertical groove, vertical protrusion, vertical flat, or combination thereof. However, these features are not evenly spaced about the circumference of the abutment. This results in the abutment having an asymmetrical cross-section. In this embodiment, the orientation feature is the asymmetry of the supragingival end of the abutment, rather than the presence of a (e.g. single) mechanical feature.

The exterior geometry of implant abutments have previously been designed in consideration of the fabrication of the subsequently seated restoration. Hence, for embodiments wherein currently commercially available implant abutments are integrated into the dental mill blank, the supragingival exterior surfaces of the abutment are generally free of any structural features that would detract from the fit between the exterior surface of the abutment and the restorative. Hence, the supragingival exterior surfaces of the abutment are generally free of undercuts, as well as deep (e.g. horizontal) grooves or protrusions (e.g. having a difference in depth of about 0.1 mm or greater).

However, since it is presently described to permanently bond at least the supragingival end of the implant abutment within the dental mill blank material prior to fabricating a (e.g. crown) restoration, the presence of undercuts and deep grooves can be present and may be advantageous for the purpose of mechanically bonding the implant abutment within the surrounding mill blank material.

As depicted in FIG. 5, the supragingival end of the implant abutment preferably comprise one or more (anti-pull) retention features, such as (e.g. shallow) grooves that hinder removal of the abutment from the mill blank portion. In some embodiments, such (anti-pull) retention features have a depth no greater than about 0.1 mm. Other (anti-pull) retention features include for example shallow horizontal flat(s), horizontal groove(s), or horizontal protrusion(s). Alternatively or in addition to mechanical retention features, the supragingival end of commercially available implant abutment can be mechanically or chemically surface modified to improve adhesive.

Such (e.g. shallow) mechanical features and/or other surface modification can increase the surface area and mechanically interlock with the surrounding mill blank material, particularly upon curing the mill blank material.

In some embodiments, the (supragingival) opposing end is roughened for example for sandblasting. The surface roughness (Ra) of the uncoated abutment may be about 1 for a metal abutment that has not been subjected to surface roughening. A sandblasted metal abutment may have a surface roughness (Ra) of about 2 to 3. As the roughness increases, the bond strength between the abutment and mill blank material or other (e.g. dental restoration) material at the abutment interface can also increase.

In some embodiments, the (supragingival) opposing end of the implant abutment comprises a coating that increases the surface roughness and/or improves the adhesion with the mill blank portion.

In one favored embodiment, the abutment comprises a shoulder (not shown) within the cavity for cooperation with a screw to fasten the abutment to the implant anchor. Since the abutment is mechanically attached to the underlying implant anchor with a screw, the entire abutment need not be rotated in order to attach the abutment to the implant anchor.

For embodiments wherein the implant abutment comprises a shoulder within the cavity for cooperation with a screw 250 to fasten the abutment to the implant anchor,

he mill blank further comprises a vertical bore, as depicted in FIG. 2 for providing access to an internal bore of the implant abutment. As depicted the vertical bore extends the entire height of the mill blank and restoration fabricated thereof. Such vertical bore 170 may be created during and/or after fabrication of the dental mill blank such as by drilling. In one embodiment, such internal bore is created during the molding of the (e.g. ceramic) dental mill blank by including such cylindrical structure within the mold cavity design. Since this internal bore is latter filled (e.g. with a polymer-ceramic composite) material, such internal bore need not be precision milled. Particularly in the case of polymer and polymer-ceramic mill blanks, such bore can be formed by drilling a hole with a simple bur. Vertical bores (also referred to as an interior cavity) that are substantially conical or cylindrical in shape can accommodate a wide variety of implant designs. The dental mill blanks can comprise of a variety of materials, provided the material is suitable for use in the oral cavity and is also capable of being milled by a milling machine without undue hindrance or tool wear. Examples of suitable materials include ceramics, polymers, polymer-ceramic composite materials, and metals.

Examples of suitable metals include stainless steel, alloys of gold or titanium, palladium-based alloys, nickel-based alloys, cobalt-based alloys or any other alloy suitable for use in the oral environment.

Examples of suitable ceramic materials include glasses, monocrystalline and polycrystalline ceramics, and glasses with crystalline phases. Polycrystalline ceramics include nanocrystalline materials and may be single phase or multiphase. Preferred crystalline ceramic materials include aluminum oxide, magnesium-aluminum spinel (MgAl₂O₄), zirconium oxide, yttrium aluminum garnet, zirconium silicate, yttrium oxide and mullite. Preferred glass containing materials include feld-pathic porcelains; glasses containing crystalline; phases such as mica, leucite, canasite, alumina, zirconia, spinel, hydroxyapatite; and amorphous glasses available as “Pyrex” and “Vycor” from Corning, Inc., Corning, N.Y.). For ceramic mill blank embodiments, the ceramic may be provided in a fully dense form, with little or no porosity, or in a porous, partially fired form. If the ceramic mill blank is porous, it may be fired to a fully dense state after milling. Alternatively, the porous ceramic mill blank may be infiltrated with, for example, a molten glass or a resin that is then hardened after infiltration.

Preferably, the (e.g. ceramic) mill blank material transmits light in the visible wavelengths in order to provide an aesthetically pleasing appearance once milled into a prosthetic and placed in the oral cavity. Preferably, the (e.g. ceramic) material is essentially colorless; i.e., it neither adds nor subtracts color to the light passing through the material to any appreciable extent. Optionally, however, colorants may be added to achieve desired shades that mimic the color of natural teeth that may be observed in certain patients.

Preferably, the (e.g. ceramic) mill blank material has a Contrast Ratio value less than about 0.7, preferably less than about 0.6, and more preferably less than about 0.5. The Contrast Ratio value can be determined by following the technique described in Section 3.2.1 of ASTM-D2805-95, modified for samples of about 1 mm thick. The Contrast Ratio value is an indication of the level of light transmissivity possessed of the resulting prosthesis.

Preferred polymer-ceramic composite mill blank materials include polymerizable resins having sufficient strength, hydrolytic stability, and non-toxicity to render it suitable for use in the oral environment. Preferably, the resin is made from a material comprising a free radically curable monomer, oligomer, or polymer, or a cationically curable monomer, oligomer or polymer. Alternatively, the resin may be made from a material comprising a monomer, oligomer or polymer comprising a free radically curable functionality and a cationically curable functionality. Suitable resins include epoxies, methacrylates, acrylates and vinyl ethers.

Polymer-ceramic composite mill blank materials comprise thermoplastic and thermosetting polymers. Suitable thermoplastic polymers include acrylic polymers such as polymethylmethacrylate, polycarbonates, nylon, polyetheretherkitone, polyurethanes, polyimides, polyamides, and polyoxymethylene material such as available from Dupont under the trade designation “Delrin”. The polymer material is typically filled with one or more types of inorganic filler as described below.

Polymer-ceramic composite mill blank materials generally comprise an (e.g. inorganic) filler. The filler is preferably a finely divided material that may optionally have an organic coating. Suitable coatings include silane or encapsulation in a polymeric matrix. The filler may be selected from one or more of many materials suitable for incorporation in compositions used for medical or dental applications, such as fillers currently used in dental restorative compositions and the like.

Suitable fillers include the various ceramic materials previously described, as well as zirconia-silica, baria-silica glass, silica, quartz, colloidalsilica, fumed silica, ceramic fibers, ceramic whiskers, calcium phosphate, fluoroaluminosilicate glass and rare-earth fluorides. Suitable fillers also include nanosize heavy metal oxide particles such as described in U.S. Pat. No. 6,387,981, which is expressly incorporated by reference herein. Other suitable fillers are described in U.S. Pat. No. 6,370,156 and “DENTAL MATERIALS WITH NANO-SIZED SILICA PARTICLES” (U.S. Ser. No. 09/428,937 filed Oct. 28, 1999), both of which are expressly incorporated by reference herein. Additional suitable fillers are described in U.S. Pat. No. 4,503,169, and U.S. Pat. No. 6,306,926, both of which are incorporated by reference herein. The fillers may be in any morphology, including spheres, platelets, whiskers, needles, fibers, ovoids, etc. or any combination of the foregoing.

Further information regarding preferred polymer-ceramic composite materials, including details of suitable compositions and method of manufacturing those materials, are set out in U.S. Pat. No. 7,255,562, incorporated herein by reference herein.

As described in US 2005/147944, the dental mill blank can be made from the class of dental compositions described by Karim et al., WO 03/015720 (“Hardenable Self-Supporting Structures and Methods”), incorporated herein by reference. Such material has sufficient malleability to be formed in shape at a temperature of about 15° C. to 38° C. These compositions generally include an uncured, hardenable resin system; an optional filler system that may include fibers and nanoscopic fillers; an initiator system; and optionally, viscosity modifiers and/or a surfactant system.

The polymerizable resin system may comprise a crystalline component. By “crystalline component” is meant that the component displays a crystalline melting point at 20° C. or above when measured in the composition by differential scanning calorimetry

(DSC). The peak temperature of the observed endotherm is taken as the crystalline melting point. The crystalline phase includes multiple lattices in which the component assumes a conformation in which there is a highly ordered registry in adjacent chemical moieties of which the component is constructed. The packing arrangement (short order orientation) within the lattice is highly regular in both its chemical and geometric aspects. The crystalline component can be polymeric or non-polymeric and can be polymerizable or non-polymerizable. The crystalline component may comprise one or more polymers such as polyester, polyether, polyolefin, polythioether, polyarylalkylene, polysilane, polyamide, polyurethane, or combinations thereof. Alternatively, the crystalline component may be a non-polymeric material. Typically, a crystalline component is considered to be non-polymeric if it has a molecular weight of less than 10,000, and more typically less than 5,000 g/mole. The crystalline component can optionally have a dendritic, hyperbranched, or star-shaped structure.

The crystalline component can include one or more reactive groups to provide sites for polymerizing and/or crosslinking. Typically, the crystalline component comprises saturated, linear, aliphatic polyester polyols containing primary hydroxyl end groups wherein the hydroxyl end groups are modified to introduce polymerizable unsaturated functional groups.

Sufficiently malleable polymer-ceramic composite mill blank materials, as just described, include an initiator for initiating polymerization of the material. For example, one class of useful initiators includes those capable of initiating both free radical and cationic polymerization. If the resin in the polymer-ceramic composite is not sufficiently hardened before milling, further hardening can be carried out after milling and before use in the oral cavity.

Alternatively, the dental mill blanks can be made from other wax-like composite materials, such as the class of dental composites described in WO 02/26197 A2 (“Wax-Like Polymerizable Dental Material, Method, and Shaped Product”); U.S. Pat. No. 5,403,188 (“Dental Crowns and Bridges From Semi-Thermoplastic Molding Compositions Having Heat-Stable Custom Shape Memory”); U.S. Pat. No. 6,057,383 (“Dental Material Based on Polymerizable Waxes”), each incorporated herein by reference. The composition for a mill blank can be blended in a variety of ways, like in a speed mixer (as described in, for example, WO 03/015720), in a sigma blade mixer, in a planetary mixer, etc. The mill blank itself can be made from this blended composition in a variety of molding methods such as injection molding, compression molding, thermoforming, pressing, calendering, etc.

Flexural strength indicates the ability for a mill blank and a milled prosthesis to withstand forces exerted on dentition and restoration. The elastic modulus characterizes the stiffness of a material. These properties can be measured according to the test method described in WO 03/015720. The flexural strength and elastic modulus of the mill blank can vary depending on the class on mill block material utilized.

Polymer mill blanks typically have a flexural strength of at least 30 MPa. In some embodiments, polymer mill blanks have a flexural strength of at least 50 MPa, 100 MPa, or 150 MPa. The elastic modulus of a polymer mill blank is typically at least 0.5 GPa, preferably at least 1.0 GPa, more preferably at least 1.5 GPa, and even more preferably at least 2.0.

Polymer-ceramic composite mill blank typically have a flexural strength of at least 50 MPa. In some embodiments, polymer-ceramic composite mill blanks have a flexural strength of at least 100 MPa, 150 MPa, or 200 MPa. The elastic modulus of a polymer-ceramic composite mill blank is typically at least 2 GPa. In some embodiments, the elastic modulus is at least 5 GPa, 7.5G Pa, or 10 GPa.

Ceramic mill blank typically have a flexural strength of at least 70 MPa. In some embodiments, ceramic mill blanks have a flexural strength of at least 100 MPa, 250 MPa, or 500 MPa. The elastic modulus of a ceramic composite mill blank is typically at least 10 GPa. In some embodiments, the elastic modulus is at least 20 GPa, 50 GPa, or 100 GPa. The sufficiently malleable mill block materials are typically free from tack and typically have an elastic dynamic modulus (i.e., elastic modulus) G′ at room temperature, as measured by a Rheometrics RDA II dynamic mechanical analyzer (Rheometric Scientific, Piscataway, N.J.) of least 200 kilopascals (kPa), preferably 500 kPa, and more preferably at least about 1000 kPa, at a frequency of about 0.005 Hz.

The mill blank materials may comprise optional additives suitable for use in the oral environment, including colorants, flavorants, anti-microbials, fragrance, stabilizers, and viscosity modifiers. Other suitable optional additives include agents that impart fluorescence and/or opalescence.

In the present invention, the dental mill blank further comprises a dental implant abutment integrated therein. Hence, the dental mill blank comprises a dental implant abutment prior to milling a (e.g. crown) dental restoration from the dental mill blank. The dental mill blank comprises a preformed dental implant abutment comprising a subgingival implant receiving end and a supragingival end. The supragingival end is permanently bonded within a solid piece of material from which a dental restoration can be milled. The dental mill blank is advantageous in that the use thereof is amenable to a more efficient process by eliminating the step of the dental practitioner or dental lab cementing the (e.g. crown) restoration onto the implant abutment. Thus, the interface between the implant abutment and mill blank material or (e.g.) crown restorative can be free of adhesive or cement.

Methods of making dental mill blanks are known in the art, such as described in U.S. Pat. No. 6,627,327; incorporated herein by reference. The method generally utilizes a mold assembly, wherein the cavity of the mold corresponds to the shape of the mill blank. Any known methods of making mill blocks can be adapted, as desired, to integrate the preformed dental implant abutment within the hardened mill blank material. In some embodiments, the dental mill block is hardened concurrently with permanently bonding the implant abutment. In this embodiment, the dental implant abutment is introduced into the method of fabricating the mill blank, before the mill blank material surrounding the abutment is hardened.

For example, in one embodiment, the method comprises providing at least the supragingival end of the dental implant abutment within a mold cavity suitable for making a dental mill blank; filling the mold cavity with a hardenable material; and solidifying the hardenable material. The dental implant abutment can be introduced either prior to after filling or partial filling of the mold cavity. In one embodiment, the mold cavity is filled with the hardenable material and the hardenable material is partially hardened prior to providing the opposing end of the dental implant abutment within the mold cavity. Alternatively, preformed dental mill blanks can be modified for inclusion of the dental implant abutment. For example, in one embodiment the method comprises forming a cavity in a a hardened or partially hardened mill blank; providing at least the opposing end of the dental implant abutment within the mill blank cavity; filling the mill blank cavity with a hardenable material; and solidifying the hardenable material. This method is particularly useful when the mill blank is a cured ceramic material and the cavity having the implant abutment is filled with a (e.g. lower viscosity) ceramic dental restoration material or polymer-ceramic composite dental restoration material. Even though the dental restoration material of the mill blank cavity may differ in composition than the hardened mill blank, the material at the implant abutment interface is a dental restoration material, rather than an adhesive. This can be favored since preformed commercially available mill blanks can be utilized. Suitable mill blanks include those commercially available under the tradename designations “CEREC Blocks” “Mark II”, (Vita Zahnfabnik, Bad Sackingen, Germany); “Empress CAD” and “IPS e. max CAD” (Ivoclar AG, Schaan, Lichtenstein); and “Paradigm C Ceramic Blocks”, and “Lava Frame Zirconia”, and “Paradigm MZ100 Blocks” (3M ESPE, St. Paul, Minn.).

Alternatively, but less preferred, a small cavity can be formed into the cured mill blank material having an appropriate depth (about equal to the height of the supragingival end) and the implant abutment may simply be affixed within such small cavity with a adhesive or a (e.g. permanent) cement. Various dental adhesives and dental cements that are known to have good adhesion to dental restoration materials may be employed. One suitable dental cement is available from 3M ESPE, (St. Paul, Minn.) under the trade designation “RelyX Unicem Self Adhesive Universal Resin Cement”. However, since the dental abutment is adhered to the mill blank outside of the mouth, only the cured adhesive or cement need be biocompatible, rather than both the uncured and cured adhesive or cement as is the case when a (e.g. crown) restoration is adhesively bonded to an implant abutment. Accordingly, various non-dental adhesive or cements can also be utilized. In this embodiment, the interface between the supragingival end of the implant abutment and the restoration material comprises an adhesive and/or cement.

In favored embodiments, the supragingival end of the implant abutment is permanently bonded in the surrounding restoration material prior to the restoration material being cured. Hence, in this embodiment, the interface between the supragingival end of the implant abutment and the restoration material is free of adhesive and/or cement.

Adhesives and cements can typically be distinguished from (e.g. permanent) restoration materials by qualitative analysis of the components and/or quantitative analysis of the inorganic filler content. In some embodiments, the interface comprises different components typically derived from the use of different polymerizable monomers or oligomers. When the adhesive or cement present at the interface comprises substantially the same polymerizable material, the adhesive or cement can typically be distinguished by its inorganic fill content. Whereas, ceramic restoration typically have a filler concentration of at least 50 wt-%, or 60 wt-%, or 70 wt-%; adhesives and cements normally have a filler content of no greater than about 30 wt-%.

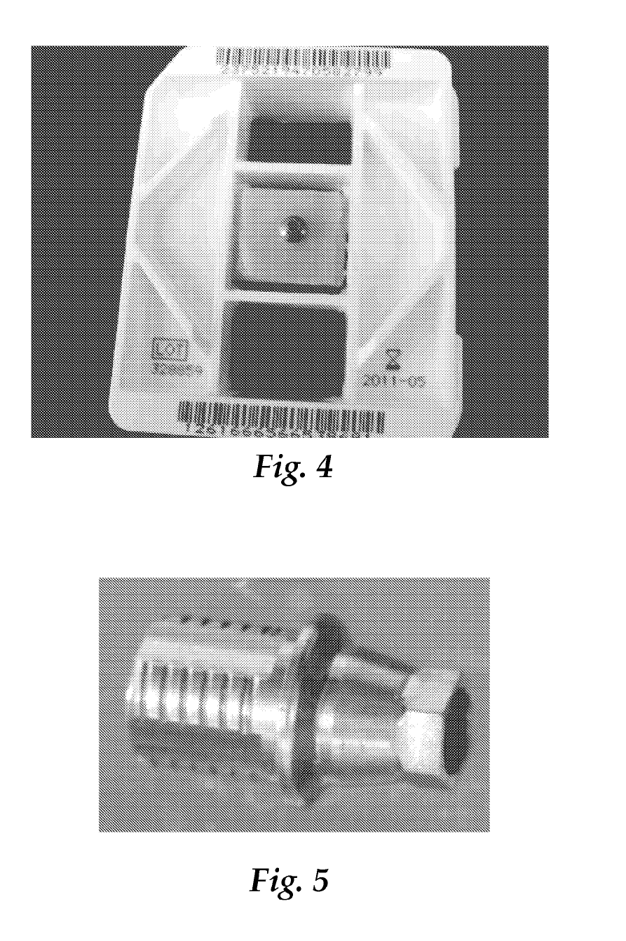

The mill bank is typically attached (e.g. adhesively bonded) to a holder such as a mandrel or frame in order to secure the dental mill blank to the milling machine. For example, FIG. 4 depicts a bottom view of a mill blank in a holder wherein the supragingival end of an implant abutment is within the mill blank. It is also contemplated however, that the milling machine could be adapted such that the implant-receiving end of the abutment could be us secure the dental mill blank to the milling machine. For example, the milling machine could include a suitably shaped (e.g. hex-shaped) recess to mate with the exposed implant receiving end of the implant mill block. The implant mill block could then be fastened to the milling machine in the same or similar manner as the implant abutment is attached to the implant anchor.

When the implant abutment has an orientation feature such as an asymmetrical cross section, care is taken in the positioning of the implant abutment within the mill blank material in order that such positioning can be conveyed to the CAD/CAM device that will subsequently mill the blank into a (e.g. crown) restoration. For example, the dental implant abutment may be positioned dead center such that an orientation feature (e.g. vertical flat 156) is parallel to the wall of the dental mill blank such as depicted in FIG. 1. Alternatively, the mold may have a marking such as a recess or protrusion on the bottom or top surface that results in the hardened mill blank material having such orientation marking aligned orthogonal to the orientation feature (e.g. vertical flat 156) of the implant abutment. In yet another embodiment, the mill blank holder may have a digital or visual marking to indicate the location of the orientation feature of the implant abutment therein. Further yet, after positioning the implant abutment within the mold cavity, but prior to covering the orientation feature with the dental mill blank material, the implant abutment could be imaged and the coordinates of the orientation feature recorded (such as by printing) on either the mill block or the holder.

A variety of dental restorations may be fabricated from the mill blanks such as bridges, crowns, custom abutments, healing caps, or other tooth replacement appliances.

Various means of milling the mill blanks of the present invention may be employed to create custom-fit dental prosthetics and other appliances having a desired shape and morphology. While milling the blank by hand using a hand-held tool or instrument is possible, preferably the prosthetic is milled by machine, including the use of power machines, electrically powered machines, and computer controlled milling equipment. A preferred device to create a prosthetic is a CAD/CAM device capable of milling a blank. Examples of such a computer-aided milling machine include the CEREC “MC XL” and “MC L Compact Milling Unit” supplied by Siemens (available from Sirona Dental Systems; Bensheim, Germany); “E4D Labworks” (available from D4D Technologies), “Lava CNC 500 Milling System” (available from 3M ESPE), “Zenotec T1” (available from Weiland, Germany), “KaVo Everest CAD/CAM System” (available from KaVo Dental Corporation, Lake Zurich, Ill.) “Digital Waxing Units” (available from Whip Mix, Louisville, Ky.), “Dental CAD/CAM System” (available from GC Corporation, Japan), “RXD5 5-axis HSC Machine” (available from Roders, Germany), and “Katana Milling Machine H-18” (available from Noritake, JP). U.S. Pat. Nos. 4,837,732 and 4,575,805 also disclose the technology of computer-aided milling machines for making dental prostheses. These machines produce dental prostheses by cutting, milling, and grinding the near-exact shape and morphology of a required restorative with greater speed and lower labor requirements than conventional hand-made procedures. By using a CAD/CAM milling device, the prosthesis can be fabricated efficiently and with precision. During milling, the contact area may be dry, or it may be flushed with or immersed in a lubricant. Alternatively, it may be flushed with an air or gas stream. Suitable liquid lubricants are well known, and include water, oils, glycerine, ethylene glycols, and silicones. After milling, some degree of finishing, polishing and adjustment may be necessary to obtain a custom fit in to the mouth and/or aesthetic appearance. After machine milling the mill blank, the net shape or near net shape article may be further hardened depending on the composition of the dental mill block material. Ceramic mill blank materials are generally subjected to firing, otherwise know as sintering. Polymer-ceramic composite material such as the sufficiently malleable material previously described can be cured. Once complete, one or more additional processing steps may be performed after the hardening step. This may include any of a variety of surface treatments or other processing steps, including trimming, polishing, coating, priming, staining, glazing, and the like. A variety of other constructions and methods are also possible and may be apparent to those skilled in the art. As such, the scope of the invention should not be deemed limited to the presently preferred embodiments.

Each of the examples employed a prototype dental implant abutment interface fabricated from CP Titanium Grade 5 (purity specification: max 0.10 C, 0.5 Fe, 0.015 H, 0.05 N, and 0.50 O, Perryman Co., Houston, a.). An optical micrograph of the dental implant abutment having a length of about 7 mm is depicted in FIG. 5.

The uncoated interface was sandblasted at 2 bars of pressure with 50 um aluminum oxide using a Vaniman Sandstorm XL (Vaniman Co., Fallbrook, Calif.), the nozzle being positioned ½″ from the interface.

### EXAMPLE 1

### Zirconia Abutment Interface in a Ceramic Mill Blank

The ceramic abutment interface was created by scanning the titanium abutment interface and using a Lava System (3M ESPE) to mill the duplicate shape from a Lava Zirconia mill blank (3M ESPE).

A Vita Mark 2 feldspathic porcelain mill blank (Vita Zahnfabrik, Germany) having a similar coefficient of thermal expansion had a 2 mm screw hole bored from one face to the opposite face, with one end of the hold further enlarged to receive the abutment interface.

VM9 Base Dentine ceramic powder (Vita) was mixed with distilled water and applied to the restoration end of the abutment interface, taking care to keep the screw hole open. The coated restoration end of the abutment interface was inserted into the enlarged end of the screw hole in the mill blank such that the space between the abutment interface and screw hole was completely filled with ceramic paste and the implant end of the abutment interface projected out of the mill blank. The assembly was fired under vacuum in a Vita Vacuumat 4000 furnace (Vita) according to manufacturer's instructions, to a final temperature of 900 deg C.

When cool, the zirconia abutment interface was firmly bonded within the porcelain mill blank with the implant end projecting from the blank.

### EXAMPLE 2

### Metal Interface in a Ceramic Mill Blank

A highspeed handpiece and diamond burr was used to form a 2 mm screw hole through a Paradigm C leucite reinforced ceramic mill blank (3M ESPE), one end of the screw hold being enlarged to accomodate the abutment interface and ceramic material.

A ceramic material (Finesse Porcelain, Dentsply, York, Pa.) was applied to the restoration end of a titanium abutment interface, taking care to keep the screw hole open. The coated restoration end of the abutment interface was inserted into the enlarged end of the screw hole in the mill blank such that the space between the abutment interface and screw hole was completely filled with ceramic paste and the implant end of the abutment interface projected out of the mill blank. The assembly was placed in a Vita furnace and sintered to a final temperature of 780 deg. C., per manufacturer's instructions.

When cool, the titanium abutment interface was firmly bonded within the ceramic mill blank having the implant end of the titanium interface exposed.

### EXAMPLE 3

### Metal Interface in a Polymeric Composite Mill Blank Having a Mandrel

A silicone mold was prepared by removing the metal mandrel of a rectangular mill blank (Paradigm™ C Block from 3M ESPE, St. Paul, Minn.). The mill blank was placed into a mass of VPS silicone impression material (Express™ Putty/Wash VPS from 3M ESPE, St. Paul, Minn.) having an approximate dimension of 6 cm×4 cm×4 cm such that the upper surface of the mill blank was flush with the level of the impression material. The impression material was allowed to cure, thereby leaving a rectangular hole when the mill blank was removed.

An 8 cm long wooden stick having a circular cross section of 2 mm diameter was lightly coated with Vaseline for release properties. The restoration receiving end of a titanium abutment interface was mounted on one end of the wooden stick. The other end of the stick was punched through the bottom of the silicone mold such that the implant receiving end of the abutment interface remained outside the mold cavity and the restoration end of the abutment interface was held within the mold cavity.

A composite filling material (Filtek™ Supreme Plus Universal restorative, shade A2B from 3M ESPE, St. Paul, Minn.) was built up in the mold by successively layering and photocuring 2-3 mm layers in a light box (Triad® Visible Light Cure System from Dentsply, York, Pa.) for 1 min. per layer. The final layer of the composite material was cured to be level with the top of the mold, thus surrounding the restoration end of the abutment interface and leaving the implant end exposed. The wooden stick was removed from the assembly and the assembly removed from the mold.

The titanium abutment interface was firmly bonded within the cured composite mill blank and the implant end of the abutment interface was projecting from the surface. Finally the previously removed metal mandrel for milling was re-attached to the composite blank using 3M Super Glue (3M St. Paul, Minn.).

### EXAMPLE 4

### Metal Abutment Interface in a Polymeric Composite Mill Blank Having a Frame

A composite mill blank having a metal abutment interface was formed as described in Example 3 except that the completed assembly was glued into the empty frame of a Lava™ Zirconia Block (3M ESPE, St. Paul, Minn.) using 3M Super Glue.

1. A method of making a dental restoration for a dental implant comprising:
acquiring a digital surface representation of at least a portion of a patient's mouth comprising a dental implant;
creating a three-dimensional digital model from the digital surface representation; and forming a restoration from the three-dimensional digital model by milling a dental mill blank; wherein the dental mill blank comprises a dental implant abutment integrated therein and the dental implant abutment comprises an orientation feature.

2. The method of claim 1 comprising attaching a dental implant abutment to the dental implant in the patient's mouth; and
scanning the patient's mouth to acquire the digital surface representation.

3. (canceled)

4. The method of claim 2 wherein the scanned dental implant abutment has the same geometry as the dental implant abutment of the mill blank.

5-10. (canceled)

11. A dental mill blank comprising:
a preformed dental implant abutment comprising a subgingival implant-receiving end and an opposing supragingival end wherein the supragingival end comprises an orientation feature and the supragingival end is permanently bonded within a solid piece of material from which a dental restoration can be milled such that an interface of the supragingival end and solid piece of material comprises a polymer-ceramic composite material.

12-13. (canceled)

14. The dental mill blank of claim 1 wherein the preformed abutment is a metal abutment, a ceramic abutment, a plastic abutment, a metal/ceramic hydrid abutment or a metal abutment interface and a ceramic abutment.

15. The dental mill blank of claim 11 wherein the dental restoration is a ceramic material, polymer material, or polymer-ceramic composite material.

16. The dental mill blank of claim 15 wherein the dental restoration comprises at least 50 wt-% filler.

17. The dental mill blank of claim 1 wherein the dental restoration has sufficient malleability to be formed in shape at a temperature of about 15° C. to 38° C.

18. The dental mill blank of claim 17 wherein the dental restoration comprises a crystalline resin component or a wax-like composite material.

19. The dental mill blank of any of claim 11 wherein the preformed abutment is a different material than the solid piece of material.

20. The dental mill blank of claim 19 wherein the preformed abutment is a metal abutment or metal abutment interface and the solid piece of material is a ceramic material or polymer-ceramic composite material.

21. The dental mill blank of claim 19 wherein the metal abutment or metal abutment interface comprises an opaque coating.

22. The dental mill blank of claim 11 wherein the solid piece of material further comprises a bore for providing access to an internal bore of the implant abutment or a partial bore for indicating the location thereof.

23. The dental mill blank of claim 11 wherein the supragingival end comprises anti-pull mechanical features, anti-rotation mechanical features, or a combination thereof.

24. The dental mill blank of claim 11 wherein the solid piece of dental material is attached to a holder selected from a mandrel or frame.

25. The dental mill blank of claim 24 wherein the holder further comprises a marking that conveys positional information about the orientation feature of the supragingival end of the implant abutment.

26. The dental mill blank of claim 1 wherein the milled dental restoration is a crown, bridge, healing cap, or implant abutment.

27. The dental mill blank of claim 26 wherein the solid piece of material has a volume that is greater than the volume of the milled dental restoration.

28. (canceled)

29. The dental mill blank of claim 11:
wherein at least the supragingival end is permanently bonded within a solid piece of polymer-ceramic composite material from which a dental restoration can be milled.

30-41. (canceled)

42. A method of making a dental mill blank comprising:
providing a preformed dental implant abutment having an implant-receiving end and an opposing supragingival end;
forming a cavity in a hardened or partially hardened mill blank;
providing at least the opposing end of the dental implant abutment within the mill blank cavity;
filling the mill blank cavity with a hardenable polymer-ceramic composite material; and
solidifying the hardenable material thereby permanently bonding at least the supragingival end to a dental mill block.

43-46. (canceled)

47. The method of claim 42 wherein the dental mill block is hardened concurrently with permanently bonding the implant abutment.

48. The method of claim 47 comprising:
providing at least the supragingival end of the dental implant abutment within a mold cavity suitable for making a dental mill blank;
filling the mold cavity with a hardenable material; and
solidifying the hardenable material.

49. The method of claim 48 wherein at least a portion of the hardenable material is partially hardened prior to providing the supragingival end of the dental implant abutment within the mold cavity.

50. The method of claim 42 further comprising providing a bore for providing access to an internal bore of the implant abutment or a partial bore for indicating the location thereof.

51. (canceled)
